(19) United States
(12) Patent Application Publication
(10) Pub. No.: US 2008/0197216 A1
(43) Pub. Date: Aug. 21, 2008

(54) Arrangement Of Joint Packing Between the Pump-Injector (Injector) Body and Nozzle Body, For Internal Combustion Engines

(75) Inventor: Boris Feinleib, Jerusalem (IL)

Correspondence Address: NATH & ASSOCIATES, 112 South West Street, Alexandria, VA, 22314, US

(73) Assignee: MAZREK LTD., Jerusalem (IL)

(21) Appl. No.: 11/578,459

(22) PCT Filed: Apr. 29, 2004
(86) PCT No.: PCT/IL04/00353

§ 371 Date: Oct. 25, 2006

(51) Int. Cl. F02M 61/16

(52) U.S. Cl. 239/533.3

(57) ABSTRACT

Arrangement of joint packing between the pump-injector (injector) body (1) and nozzle body (2) for internal combustion engines, primarily diesels, wherein in order to increase the specific pressures between the faces of joined precision surfaces of pump-injector (injector) body (1) and nozzle body (2) (and also when there is an insert (3) installed between said faces) pressed together by a nut (9), said surfaces have a reduced contact area achieved by bounding these surfaces by a contour line (17) surrounding the channels reaching out to said joints. This allows for reliable sealing (joint packing) between pump-injector (injector) body (1), nozzle body (2), and the face of the insert (3) at high injection pressures (2500 Bar and higher).

### TECHNICAL FIELD

The invention relates to the field of fuel supply systems for internal combustion engines, specifically to diesels and, more specifically, to their hydraulically driven pump-injectors and to conventional pump-injectors.

### BACKGROUND ART

In order to achieve greater fuel efficiency and lower exhaust emission, the injection pressure in modern diesels, especially in high-power diesels, should be increased to about 2000-2500 Bar and more. This imposes stricter requirements for the reliability of the joint packing between the pump-injector (or injector, hereinafter “pump-injector”) body and the body of the nozzle which in conventional fuel systems is connected to the pump-injector body by a tightening nut. To ensure the required tightness of the joint packing, the specific pressures between the adjoining surfaces of said bodies should be 50-70% higher than the actual injection pressures. To achieve this, the force required to keep these bodies together is usually created by a tightening nut, which leads to the increased tension in the nut itself; this may affect the nut strength, lead to increased deformation of the nozzle body and reduce the pump-injector reliability.

### DISCLOSURE OF INVENTION

In the proposed arrangement of the joint packing between the pump-injector body and nozzle body, the increase of the specific pressures in the joint required at high injection pressures is achieved not by increasing the force of keeping said bodies together by a tightening nut, but by reducing the contact area of the face surfaces of the pump-injector and nozzle bodies.

In accordance with the invention, the design environment for the proposed invention contains pump-injector and of nozzle bodies that have flat precision sealing faces contacting each other; the ends of communicating high pressure channels located in said bodies, and bores for the pins centering the bodies reach out to the surface of said faces. In accordance with the invention, these bodies contact each other along the surface bounded by a contour line so that the area of contacting surfaces that seal said faces is smaller than the area corresponding to the total area of the face of the nozzle body determined by the outer diameter of the nozzle body. In accordance with the invention, the contour line bounding the contacting area of the faces of the pump-injector and nozzle bodies can be a single closed line, or consist of individual closed sections. The distance between points on said contour line and the internal surface of said channels and bores made for the centering pins should be equal or greater than the distance between the internal surface of the ends of high-pressure channels in nozzle body and the outer contour of the nozzle body face. The arrangement of joint packing between the pump-injector and nozzle bodies described above allows for reducing the area of the contacting surfaces of the joint by a factor of 1.5-2 and thus increasing the specific pressure in the joint without exceeding the allowable tightening force of the nut, and providing the conditions for the required level of sealing and reliable functioning of the joint at high injection pressures.

### SUMMARY OF THE INVENTION

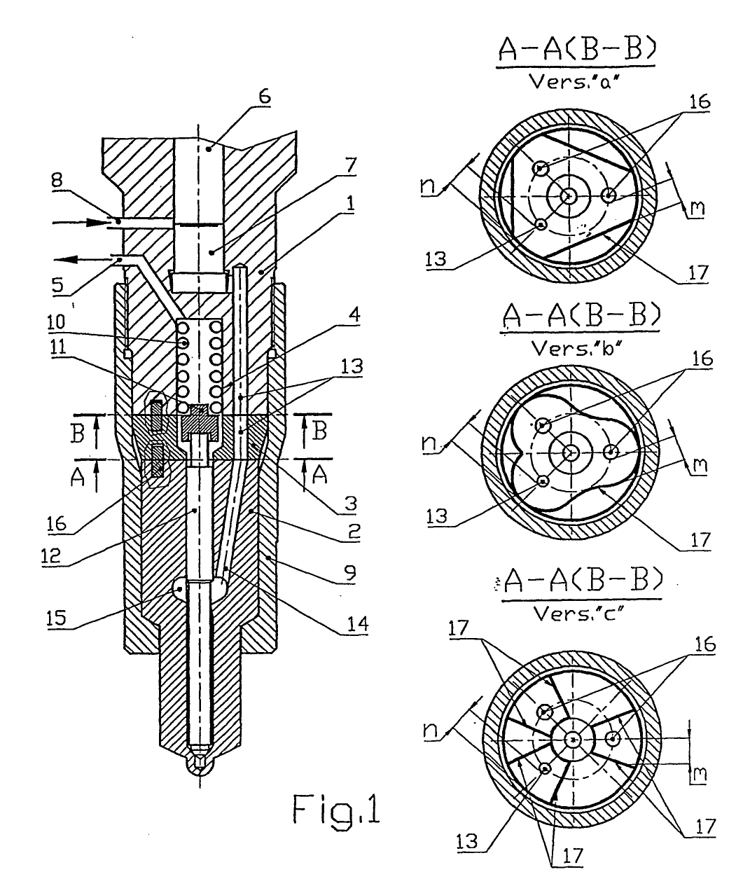

FIG. 1 shows a functional diagram of joint packing in accordance with the invention illustrated by a hydraulically driven pump-injector, where (a), (b) and (c) illustrate possible contours of the contact surfaces of the faces of the pump-injector and nozzle bodies.

In FIG. 1: 1—pump-injector body; 2—nozzle body; 3—insert between the pump-injector and nozzle bodies; 4—cylindrical cavity in pump-injector body 1; 5—channel in the pump-injector body connecting cavity 4 with the drain tank; 6—plunger; 7—under-plunger cavity; 8—channel in the pump-injector body, through which the under-plunger cavity is filled; 9—tightening nut; 10—the return spring of the nozzle unit needle; 11—spring support; 12—nozzle unit needle; 13—channels in pump-injector body 1 and insert 3, through which the fuel from under-plunger cavity is supplied to the nozzle body; 14—channel in nozzle body through which the fuel is supplied from channel 13 into cavity 15 of the nozzle body; 15—cavity in nozzle body; 16—pins centering the bodies of the pump-injector and nozzle with insert 3; 17—contour lines bounding the sealing contacting surfaces of joints A-A and B-B. Below the description of the lower part of hydraulically driven pump-injector with the arrangement of joint packing in accordance with the invention is given.

In pump-injector body 1 in the area adjacent to insert 3, cylindrical cavity 4 is formed which communicates with the drain tank through channel 5, plunger 6 being also located and moving in said body. Under-plunger cavity 7 is filled with fuel through channel 8. Pump-injector body 1 and nozzle body 2 are pressed to insert 3 by nut 9. In said cavity 4, return spring 10 is disposed which transfers the force through support 11 to nozzle needle 12. The lower face of insert 3 limits the travel of the needle which is pressed upon said face during its travel upward. Under-plunger cavity 7 is connected via high-pressure channels 13 in body 1 of the pump-injector and in insert 3, and also through channel 14 in nozzle body 2 with internal cavity 15 of the nozzle unit. The bodies of the pump-injector and of the nozzle and the insert are centered with respect to each other by pins 16. Ends of channels 13 and 14, and bores of pins 16 out to the sealing surfaces of joints A-A and B-B, and the purpose of the joint packing is prevention of fuel leaks through abovementioned channels and bores. Contour lines 17 bounding the contacting surfaces of the faces shown in FIG. 1 (a, b, c) are possible examples of the form of the contacting sealing surfaces.

### BEST MODE FOR CARRYING OUT THE INVENTION

As mentioned above, the contour lines bounding the contacting surfaces of the joint can be made continuous (FIGS. 1a and 1b), or discontinuous and discrete (dashed) (FIG. 1c). The form of the contour line should be selected based on the actual design of the bodies of the pump-injector and nozzle units. It should be provided that the minimum distance (bridge “m”, see FIG. 1) between the inner surface of the channels and the bores for pins coming out to the sealing joints, and the contour lines are equal or greater than the distance “n” (bridge “n”, see FIG. 1) between said bores and outer contour of the cylindrical nozzle body. Such limiting of the “m” distance ensures a reliable joint sealing at high pressures (2500 Bar and higher) which is not less reliable than conventional systems where the injection pressures do not exceed 1000-1200 Bar.

Providing a reduced contact area of the contacting sealing surfaces is easiest on the pump-injector body and on the insert. In this case, one can use conventional designs of nozzle units and their bodies which are manufactured using a special technology.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respect as illustrative and not restrictive, the scope of the invention being indicated by the appended claims rather than by the foregoing description, and all changes which come within the meaning and range of equivalency of the claims are therefore intended to be embraced therein.

### INDUSTRIAL APPLICABILITY

Arrangement of joint packing between the pump-injector (injector) body and the nozzle body in accordance with the invention can be used for sealing the joints both in conventional injectors and in pump-injectors. It is especially advisable to use the joint packing in accordance with the invention in hydraulically driven pump-injectors. This is because in hydraulically driven pump-injectors, high injection pressures are normally used (2000 Bar, which may soon increase to 2500 Bar and higher) requiring a reliable sealing of said joint without increasing the tightening force of the tightening nut. The problem of sealing the joints is important because we are dealing with larger injectors which are typical of large diesels, such as diesels used for off-road vehicles, locomotives, and marine applications and have larger face areas and, consequently, larger areas of contacting surfaces. Therefore the joint packing in accordance with the invention should be preferably used in diesels of the above mentioned applications.

I claim:

1. Arrangement of joint packing between the pump-injector (injector) body and nozzle body for internal combustion engines primarily diesels, comprising a body of the pump-injector (injector) and a nozzle body (between which an insert can be installed), having flat precision faces directly contacting each other, said faces having ends of communicating high-pressure channels in the pump-injector body, insert and nozzle body reaching out to their surfaces, said parts being centered one in relation to another by pins whose bores also reach out to said faces, the faces being pressed together by a tightening nut, the proposed arrangement being distinguished by the fact that said faces of the pump-injector body, insert and nozzle body contact each other along a surface bounded by a contour line surrounding said channels and bores in such a way that the area of contacting surfaces along which said faces are sealed is smaller than the area corresponding to the total area of the face of the nozzle unit body bounded by the maximum outer diameter of the nozzle body.

2. Arrangement of joint packing according to claim 1, wherein said contour line bounding the surface along which the pump-injector (injector) body, insert and nozzle body contact each other, can be a single closed continuous line or can consist of separate closed sections, the distance between the points of said contour line and internal surface of said channels, and pin bores in said bodies and insert being smaller than the distance between internal surface of the ends of the channels in nozzle body and the outer contour of the nozzle body.
